(19) United States
(12) Patent Application Publication
(10) Pub. No.: US 2026/0180832 A1
(43) Pub. Date: Jun. 25, 2026

(54) ARTIFICIAL INTELLIGENCE BASED DECISION-DIRECTED CHANNEL ESTIMATION

(71) Applicant: Samsung Electronics Co., Ltd., Suwon-si (KR)

(72) Inventors: Mehmet Mert Sahin, Frisco, TX (US); Xinliang Zhang, Plano, TX (US); Young Han Nam, Plano, TX (US)

(21) Appl. No.: 19/354,817

(22) Filed: Oct. 9, 2025

Related U.S. Application Data
(60) Provisional application No. 63/737,157, filed on Dec. 20, 2024.

(51) Int. Cl. H04L 25/02; H04L 41/16; H04W 72/21

(52) U.S. Cl. CPC H04L 25/0242; H04L 41/16; H04W 72/21

(57) ABSTRACT

A method is performed by a first electronic device. The method includes: receiving a data collection capability report from a second electronic device in response to a request; transmitting, a data collection configuration and a data collection request to the second electronic device, the data collection configuration including data types for data collection and signal reconstruction parameters; receiving a data package including uplink data from the second electronic device based on the data collection configuration and the data collection request, the uplink data associated with uplink signals from user equipments; reconstructing the uplink signals using respective decoded transport blocks and the signal reconstruction parameters; and estimating a channel matrix and an interference and noise covariance matrix using the reconstructed uplink signals.

### CROSS-REFERENCE TO RELATED APPLICATION AND CLAIM OF PRIORITY

The present application claims priority under 35 U.S.C. § 119(e) to U.S. Provisional Patent Application No. 63/737,157 filed on Dec. 20, 2024, which is hereby incorporated by reference in its entirety.

### TECHNICAL FIELD

This disclosure relates generally to wireless communication systems. More specifically, this disclosure relates to apparatuses and methods for artificial intelligence (AI) based decision-directed channel estimation (DDCE) in wireless communication systems.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides AI-based DDCE methods and apparatuses in wireless communication systems.

In one embodiment, a method is provided. The method includes: receiving, at a first electronic device, receiving, by a first electronic device, a data collection capability report from a second electronic device in response to a request; transmitting, by the first electronic device, a data collection configuration and a data collection request to the second electronic device, the data collection configuration including data types for data collection and signal reconstruction parameters; receiving, by the first electronic device, a data package including uplink data from the second electronic device based on the data collection configuration and the data collection request, the uplink data associated with uplink signals from UEs; reconstructing, by the first electronic device, the uplink signals using respective decoded transport blocks and the signal reconstruction parameters; and estimating, by the first electronic device, a channel matrix and an interference and noise covariance matrix using the reconstructed uplink signals.

In another embodiment, a first electric device includes: a memory and a processor operably coupled to the memory. The processor is configured to: receive a data collection capability report from a second electronic device in response to a request; transmit a data collection configuration and a data collection request to the second electronic device, the data collection configuration including data types for data collection and signal reconstruction parameters; receive a data package including uplink data from the second electronic device based on the data collection configuration and the data collection request, the uplink data associated with uplink signals from UEs; reconstruct the uplink signals using respective decoded transport blocks and the signal reconstruction parameters; and estimate a channel matrix and an interference and noise covariance matrix using the reconstructed uplink signals.

In yet another embodiment, a non-transitory computer readable medium embodying a computer program is provided. The computer program includes program code that, when executed by a processor of a first electronic device, causes the first electronic device to: receive a data collection capability report from a second electronic device in response to a request; transmit a data collection configuration and a data collection request to the second electronic device, the data collection configuration including data types for data collection and signal reconstruction parameters; receive a data package including uplink data from the second electronic device based on the data collection configuration and the data collection request, the uplink data associated with uplink signals from UEs; reconstruct the uplink signals using respective decoded transport blocks and the signal reconstruction parameters; and estimate a channel matrix and an interference and noise covariance matrix using the reconstructed uplink signals.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example base station according to embodiments of the present disclosure;

FIG. 3 illustrates an example user equipment according to embodiments of the present disclosure;

FIG. 4 illustrates an example network device according to embodiment of the present disclosure;

FIG. 5 illustrates an example open radio access network (O-RAN) according to embodiments of the present disclosure;

FIG. 6 illustrates an example uplink (UL) signal processing according to embodiments of the present disclosure;

FIG. 7 illustrates an example UL signal including demodulation reference signal (DMRS) according to embodiments of the present disclosure;

FIG. 8 illustrates an example UL signal processing according to embodiments of the present disclosure;

FIG. 9 illustrates an example forward error correction (FEC) decoding operation of a demultiplexed UL data stream according to embodiments of the present disclosure;

FIG. 10 illustrates an example reconstruction of UL data streams for AI-based DDCE according to embodiments of the present disclosure;

FIG. 11 illustrates an example FEC encoding operation of decoded UL data streams according to embodiments of the present disclosure;

FIG. 12 illustrates an example AI-based DDCE framework according to embodiments of the present disclosure;

FIG. 13 illustrates an example reconstruction of a UL signal at an RAN intelligent controller (RIC) according to embodiments of the present disclosure;

FIG. 14 illustrates an example signaling for UL data collection between an RIC and an open distributed unit (O-DU) according to embodiments of the present disclosure;

FIG. 15 illustrates an example data collection capability report from an O-DU for UL data collection according to embodiments of the present disclosure;

FIG. 16 illustrates an example UL data collection and condition configuration according to embodiments of the present disclosure;

FIG. 17 illustrates an example on-demand data collection configuration signaled from an RIC according to embodiments of the present disclosure;

FIG. 18 illustrates an example data collection request from an RIC according to embodiments of the present disclosure;

FIGS. 19A-19D illustrate example collection time windows in a data collection request according to embodiments of the present disclosure; and

FIG. 20 illustrates an example flow chart for an AI-based DDCE method according to embodiments of the present disclosure.

### DETAILED DESCRIPTION

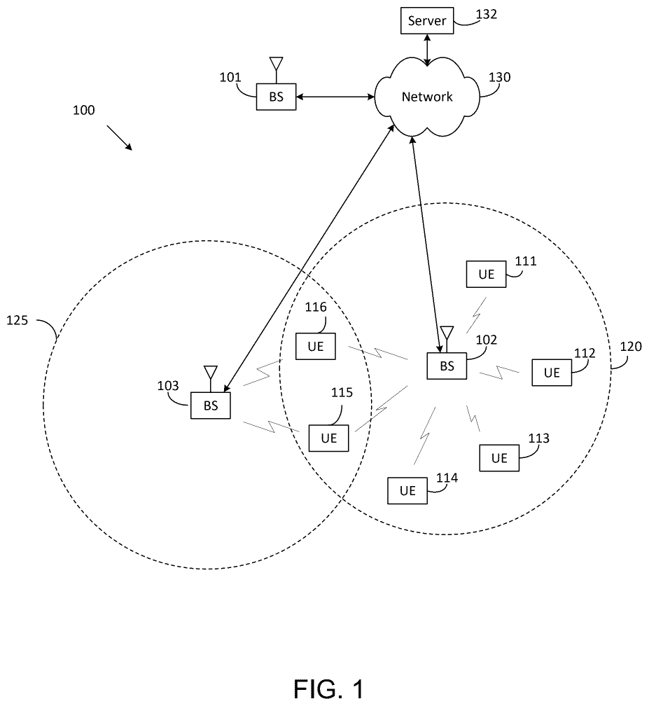

FIGS. 1 through 20, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-5 below describe various embodiments implemented in wireless communications systems and with the use of orthogonal frequency division multiplexing (OFDM) or orthogonal frequency division multiple access (OFDMA) communication techniques. The descriptions of FIGS. 1-5 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB (e.g., base station, BS) 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

The wireless network 100 may be an AI-based cellular system. As such, the at least one network 130 may be operably coupled to a network device (e.g., without limitation, a server) 132 configured to, for example and without limitation, receive data from the gNBs 101-103 via backhaul/network interfaces and train and/or test an AI model to perform channel estimation. The server 132 may represent one or more servers, and each server 132 includes a suitable computing or processing device for training and/or testing the AI model. Each server 132 could, for example, include one or more processing devices, one or more memories storing instructions and data, and one or more network interfaces to receive the data. The AI model can then be trained, tested and deployed to effectively perform channel estimation for reliable and efficient communications in the wireless communication network 100.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support the gNB 101-103 for performing wireless communications tasks. In certain embodiments, one or more of the gNBs 101-103 include circuitry, programing, or a combination thereof, to perform AI-based decision-directed channel estimation.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

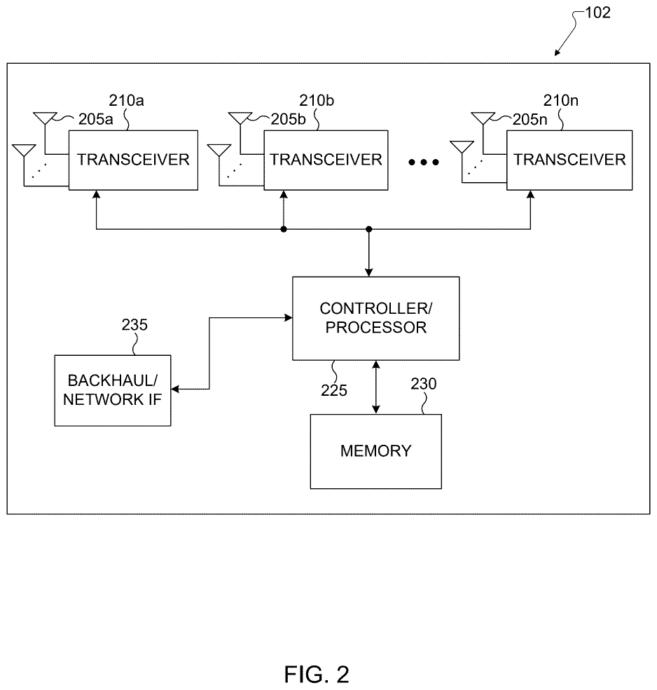

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to perform AI aided channel estimation as discussed further in detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

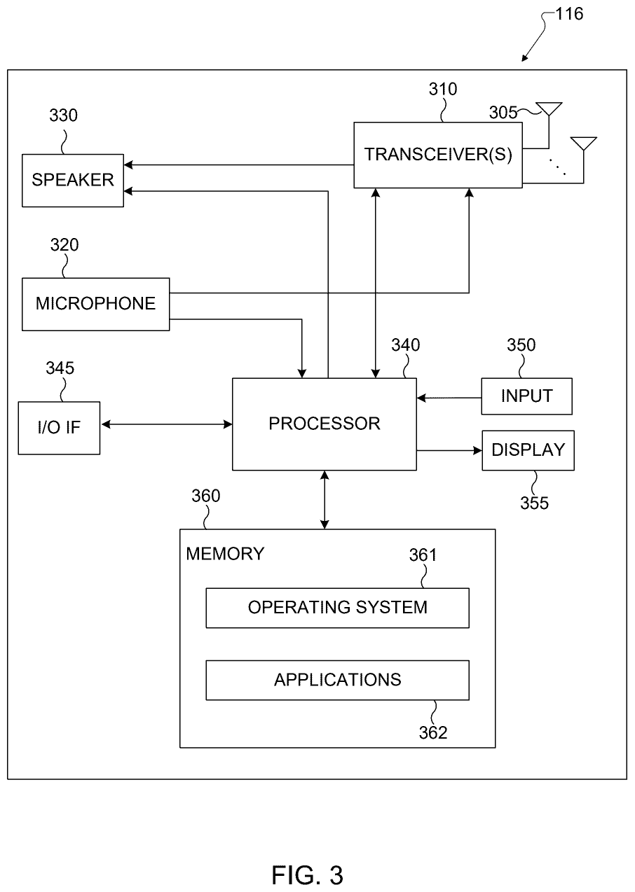

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to support AI-based decision-directed channel estimation as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

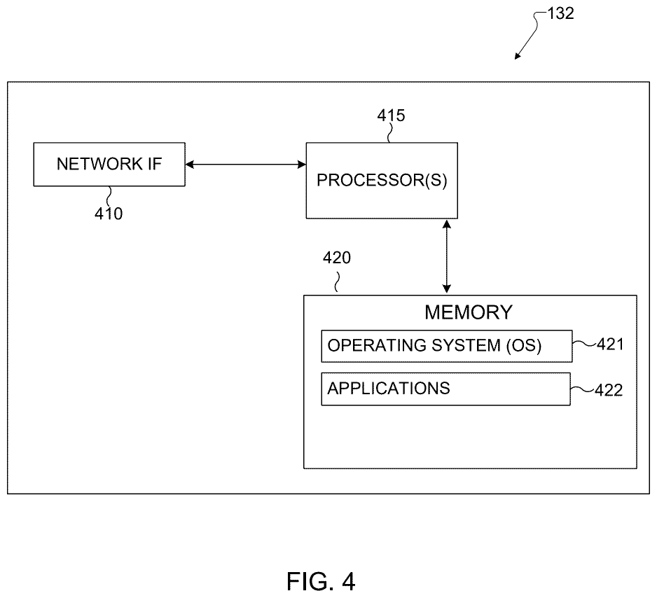

FIG. 4 illustrates an example network server 132 according to embodiments of the present disclosure. The embodiment of the server 132 illustrated in FIG. 4 is for illustration only. Different embodiments of servers 132 could be used without departing from the scope of this disclosure.

The server 132 may be a computing device including at least a network interface 410, a processor 415 and a memory 420. The network interface 410 may support communications over any suitable wired or wireless connection(s). It may include any suitable structure supporting communications over a wired or wireless connection, such as an Ethernet or transceiver. The network interface 410 may be, for example and without limitation, network interface cards (NICs) or network ports. The server 132 may receive data from the gNBs 101-103 via the network interface 410, the UEs 111-116 via the gNBs 101-103, or any other appropriate sources. The server 132 may also train and/or test an AI model to perform channel estimation as discussed further in detail below. The server 132 may then.

The processor 415 is coupled to the network interface 410 and can include one or more processors or other processing devices. The processor 415 can execute instructions that are stored in the memory 420, such as the OS 421 in order to control the overall operation of the server 132. The processor 415 can include any suitable number(s) and type(s) of processors or other devices in any suitable arrangement. For example, in certain embodiments, the processor 415 includes at least one microprocessor or microcontroller. Example types of processor 415 include microprocessors, microcontrollers, digital signal processors, field programmable gate arrays, application specific integrated circuits, and discrete circuitry. In certain embodiments, the processor 415 can include a neural network such as an AI CE model as well as a CPU, a GPU or a tensor processing unit (TPU) that provides significant computational resources for training the AI CE model.

The processor 415 is also capable of executing other processes and programs resident in the memory 420, such as operations that receive and store data. As described in greater detail below, the processor 415 may execute processes to train and/or test an AI CE model to perform channel estimation in the wireless communication systems. The processor 415 can move data into or out of the memory 420 as required by an executing process. In certain embodiments, the processor 415 is configured to execute the one or more applications 422 based on the OS 421 or in response to signals received from external source(s) or an operator. Example applications 422 can include an AI training application for the AI model.

The memory 420 is coupled to the processor 415. Part of the memory 420 could include a RAM, and another part of the memory 420 could include a Flash memory or other ROM. The memory 420 can include persistent storage (not shown) that represents any structure(s) capable of storing and facilitating retrieval of information (such as data, program code, and/or other suitable information). The memory 420 can contain one or more components or devices supporting longer-term storage of data, such as a read only memory, hard drive, Flash memory, or optical disc.

Although FIG. 4 illustrates one example of the server 132, various changes can be made to FIG. 4. For example, various components in FIG. 4 can be combined, further subdivided, or omitted and additional components can be added according to particular needs. As a particular example, the processor 415 can be divided into multiple processors, such as one or more central processing units (CPUs), one or more graphics processing units (GPUs), one or more neural networks, and the like.

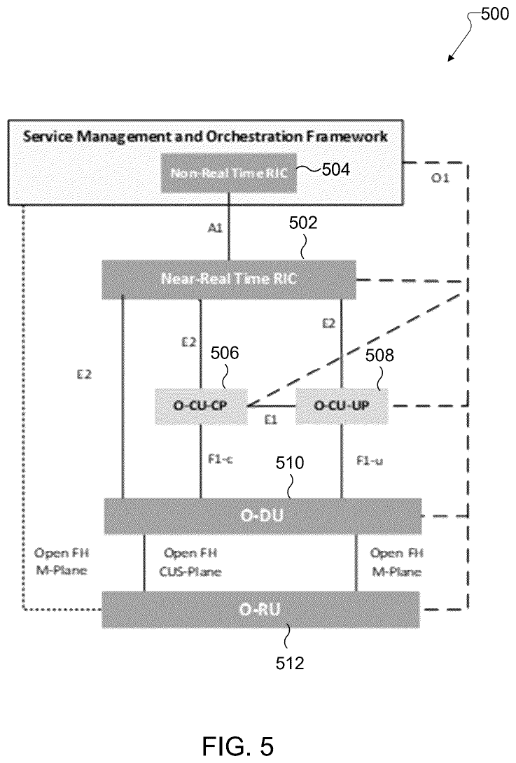

FIG. 5 illustrates an example architecture of an O-RAN 500 according to embodiments of this disclosure. The O-RAN 500 may be a next generation network beyond 5G and 6G, representing a concerted effort to shift towards more intelligent, open, virtualized and interoperable network systems. The embodiment of the O-RAN 500 shown in FIG. 5 is for illustration only. Other embodiments of the O-RAN 500 could be used without departing from the scope of this disclosure.

As illustrated in FIG. 5, the O-RAN 500 may be a virtualized RAN established on an open hardware and cloud with an embedded AI-powered radio control. It may include a near-real-time RAN Intelligent Controller (near-RT RIC) 502, a non-RT RIC 504, an O-RAN Central Unit-Control Plane (O-CU-CP) 506, an O-RAN Central Unit-User Plane (O-CU-UP) 508, an O-RAN Distributed Unit (O-DU) 510, and an O-RAN Radio Unit (O-RU) 512. The near-RT RIC 502 may facilitate real-time control and optimization of O-RAN components by collecting data and executing actions via the E2 interface. The non-RT RIC 504 may support non-real-time tasks, including AI and/or ML (referred to herein as AI/ML or AI) workflows, policy-based management, and coordination to optimize near-RT RIC applications. The O-CU-CP 506 and the O-CU-UP 508 may manage user and control plane operations, while the O-DU and O-RU contribute to the modularity and functionality of the O-RAN ecosystem. Throughout the disclosure, RIC term is used to refer Non-Real Time RIC which possesses O-1 interface to communicate CU, DU, and RU entities.

The O-CU-CP 506 may provide a connection to a core network via a backhaul link, and the O-CU-UP 508 may communicate with one or more O-DUs 510 via a midhaul link. The O-DU 510 and the O-RU 512 may play crucial roles in the O-RAN architecture by managing different layers of functionality.

The O-DU 510 may be an electronic device (e.g., a base station 101-103 of FIGS. 1 and 2) and provide network functions such as radio link control (RLC) or medium access control (MAC) functions. It may communicate with one or more O-RUs 512 to provide lower layer network functions, such as lower layer physical (PHY) and/or radio frequency (RF) functions. One or more O-RUs 512 may provide direct RF connection with one or more UEs or other nodes. Thus, in the O-RAN 500 a classical transmit/receive chain for uplink and downlink is split across the O-RUs 512, the O-DUs 510, and the O-CU-CP/UP 506, 508 based on factors such as a need for centralized compute, complexity requirements to the O-RUs 512 that include actual radio frequency (RF) antennas, and consequential requirements on capacity of a fronthaul link and a midhaul link. Multiple O-RUs 512 may be connected to an O-DU 510 and multiple O-DUs 510 may be connected to an O-CU-UP 508.

In this way, the O-RAN 500 may allow interoperability between cellular network equipment provided by different mobile service providers, thereby allowing spectrum sharing by the mobile network providers while differentiating their key performance indicators (KPIs).

Although FIG. 5 illustrates one example architecture of the O-RAN 500, various changes can be made to FIG. 5. For example, various components in FIG. 5 can be combined, further subdivided, or omitted and additional components can be added according to particular needs.

Optimal performance in wireless networks on the uplink (UL) direction relies heavily on accurate channel state information (CSI) at the network for, e.g., data decoding, port reduction, and scheduling. The accurate CSI at the network may be also essential for effective precoding in the downlink (DL) direction, particularly in time division duplex (TDD) systems. In general, CSI estimation for uplink data decoding at a BS may leverage demodulation reference signal (DMRS) symbols transmitted over physical uplink shared channel (PUSCH). However, limited DMRS density in dynamic and interference-prone environments such as high-mobility or MU-MIMO scenarios can degrade performance.

AI/ML algorithms are increasingly adopted in the wireless industry, enhancing performance across all layers of wireless communication systems. These algorithms enable end-to-end network optimization, supporting higher data rates, broader coverage and adaptive capacity in diverse frequency bands. By continuously refining models through ongoing data collection, these technologies allow the models to adapt to specific deployment conditions, effectively address coverage challenges and maximize the capacity potentials thereof.

The UL data processing based on statistical signal processing techniques, however, faces challenges such as channel aging and estimation errors due to sparse DMRS symbols. AI/ML based DDCE at an RIC can address these issues, but clear mechanisms for collecting the UL data in an O-DU and transferring the UL data into the RIC are needed to train these models effectively.

This disclosure provides an AI-based DDCE framework using UL transmission from scheduled UEs in an O-RAN. The framework may include a signaling between the RIC and O-DU/O-RU/O-CU to collect UL related parameters for training an AI-based DDCE module. The signaling includes a capability report exchange between the RIC and the O-DU, a data collection and condition configuration setup, a data collection request, and a collected data transfer using O1 interface or open fronthaul M-plane interface. Based on the data collection and condition configuration and the data collection request, the O-DU may collect UL related data. Once the conditions to data transfer are satisfied, the O-DU may transmit UL data needed (e.g., UL scheduling fields, decoded raw data, and received baseband signal) for performing DDCE to the RIC. An O-RU may only send received signal data to the RIC through the O1 interface or via open fronthaul M-plane interface. An O-CU may directly transmit UL related parameters configured via RRC to the RIC through the O1 interface. The RIC may evaluate the AI-based DDCE and equalization module and generate a model update command if needed.

By leveraging PUSCH data as training data for a DDCE AI model at the RIC, the AI-based DDCE framework according to the present disclosure can allow the DDCE AI model to optimize channel estimation weights and interference covariance matrices, improving the channel estimation and MIMO equalization process at the O-DU.

The following references are incorporated herein by reference.
1. 3GPP, “NR; Radio Resource Control (RRC); Protocol specification,” 3rd Generation Partnership Project, TS 38.331.
2. 3GPP, “NR; Physical layer procedures for data,” 3rd Generation Partnership Project, TS 38.214.

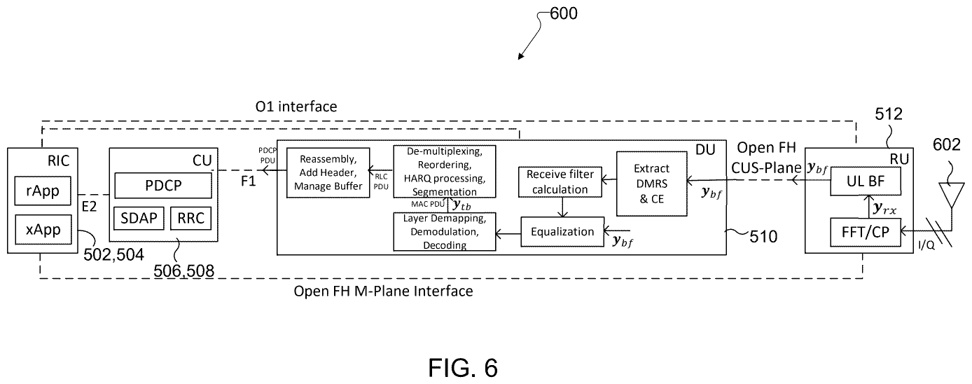

FIGS. 6-20 illustrate non-limiting embodiments of the AI-based direction-directed channel estimation methods and apparatuses, the resultant benefits, and related concepts thereof in greater detail in accordance with the present disclosure.

FIG. 6 illustrates an example UL signal processing 600 in an O-RAN 500 according to embodiments of the present disclosure. An embodiment of the example UL processing illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of UL processing could be used without departing from the scope of this disclosure.

As illustrated in FIG. 6, the O-RU 512 may receive a raw UL signal (e.g., a PUSCH waveform from a UE) via antennas 602. The O-RU 512 may remove a cycle prefix (CP) and perform Fast Fourier Transform (FFT) on time-domain samples to convert the samples to frequency domain in-phase and quadrature (IQ) samples (Yᵣₓ), which represent the received UL signal across subcarriers and ports. The O-RU 512 may apply beamforming weights to the Yᵣₓ to produce beamformed samples Y_{bf} and output Y_{bf} to the O-DU 510 via the open fronthaul control, user, and synchronization (CUS) plane.

The O-DU 510 may perform PHY layer processing such as the DMRS extraction and channel estimation, followed by receive filter calculation and equalization. The O-DU 510 may demap the equalized multi-layered symbols to logical channels, convert the symbols to soft bits (Log-likelihood ratios (LLRs)), and perform FEC decoding of transport blocks (TBs) and UCI. The O-DU 510 may also perform MAC and RLC layer related processes. The MAC layer in the O-DU 510 may receive the decoded TBs from the PHY layer. The O-DU 510 may demultiplex MAC PDU, recorder MAC service data units (SDUs), perform HARQ processing and/or segment large MAC SDUs into RLC PDUs. The RCL layer in the O-DU 510 may receive RLC PDUs from the MAC layer, reassemble segmented RLC PDUs into complete PDCP SDUs, add RLC headers and/or manage a buffer. The buffered PDUs may be transmitted to an O-CU 506,508 via the F1 interface.

The O-CU 506, 508 may perform higher-layer processing (e.g., packet data convergence protocol (PDCP), service data adaptation protocol (SDAP), RRC) and transfer data (e.g., UL metrics including BLER, throughput or CSI) to the RIC 502, 504 via the E2 interface.

The RIC 502,504 may host applications. For example, a near-RT RIC 502 may host xApp to perform near real-time tasks such as analyzing UL metrics, optimizing scheduling and outputting control messages. A non-RT RIC 504 may host rAPPs for performing non-real-time tasks such as training AI/ML models. Note that the UL signal processing 600 performs CE utilizing DMRS symbols, exposed to the challenges in dynamic and interference-prone environments due to sparse DMRS symbols.

Although FIG. 6 illustrates one example UL signal processing 600, various changes may be made to FIG. 6. For example, various components or functions in FIG. 6 may be combined, further subdivided, replicated, omitted, or rearranged and additional components or functions may be added according to particular needs.

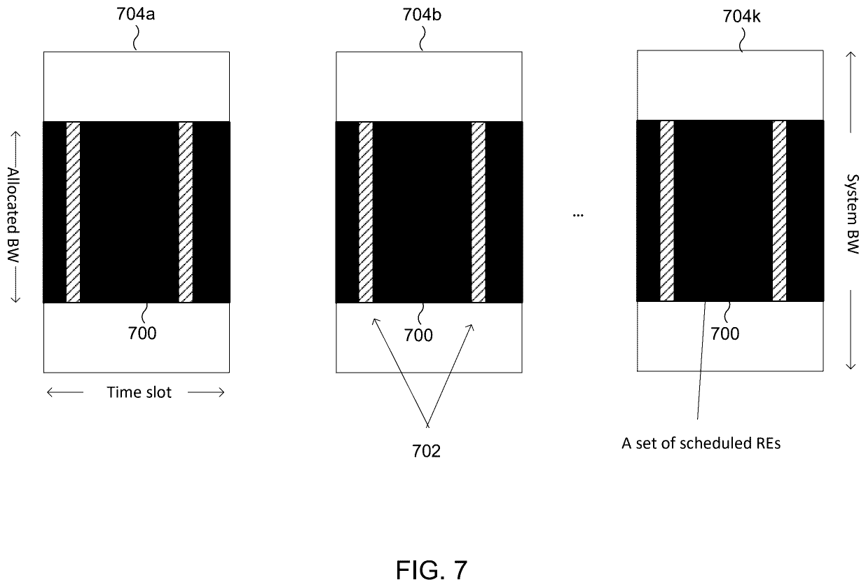

FIG. 7 illustrates an example UL signal 700 including DMRS 702 according to embodiments of the present disclosure. An embodiment of the example UL signal illustrated in FIG. 7 is for illustration only. Other embodiments of a UL signal (e.g., more or less DMRS symbols transmitted) could be used without departing from the scope of this disclosure.

The UL received signal 700 may be down converted and beamformed at an O-RU 512. The UL received signal 700 may be subsequently sampled on N_{R} DU ports 704a-704k, where one or two symbols in an OFDM time slot include DMRS 702. DMRS 702 may carry a known signal where channel estimation can be performed to help actual data decoding.

The received signal 700 on N_{R} DU ports 704a-704k at the i^{th} subcarrier, yᵢ [symbol] can be written as follows:

$${y}_{i} = {\sum }_{k = 1}^{K} {H}_{eff , i}^{( k )} {x}_{i}^{( k )} + {w}_{i}^{( k )} , \qquad ( 1 )$$

Here,

$${H}_{eff , i}^{( k )} ∈ {ℂ}^{{N}_{R} \times {N}_{L}^{( k )}}$$

is the effective channel seen between the kth user and a BS at the ith subcarrier,

$${x}_{i}^{( k )} ∈ {ℂ}^{{N}_{L}^{( k )} \times 1}$$

is the kth user transmitted signal and

$${w}_{i}^{( k )} ∈ {ℂ}^{{N}_{R} \times 1}$$

is the noise vector at the BS.

$${N}_{L}^{( k )}$$

is the number of streams transmitted by the kth user. From total of K users, the BS may receive

$${N}_{L} = {\sum }_{k = 1}^{K} {N}_{L}^{( k )}$$

data streams in a given UL MU-MIMO scenario. In order to extract every user stream separately, the BS may apply MMSE-IRC (minimum mean square error-interference rejection combining) based MIMO equalizer, W∈ [symbol] , as follows:

$${W}_{i} = {( {H}_{eff , i}^{H} {R}_{I + N , i}^{- 1} {H}_{eff , i} + I )}^{- 1} {H}_{eff , i}^{H} {R}_{I + N , i}^{- 1} , \qquad ( 2 )$$

Here,

$${H}_{eff , i} = [ {H}_{eff , i}^{( 1 )} , … , {H}_{eff , i}^{( K )} ] ∈ {ℂ}^{{N}_{R} \times {N}_{L}}$$

is the stacked effective channels from all UEs at the ith subcarrier. Interference and noise covariance matrix is denoted as R_{I+N,i}∈ [symbol] .

In general, systems may utilize DMRS signals to estimate both

$${H}_{eff , i}^{H}$$

and R_{I+N,i}, resulting in numerous limitations including:
Less number of DMRS samples available as compared to the number of PUSCH samples as shown in FIG. 7.
Potential singularity of the estimate R_{I+N,i} when

$${N}_{RE}^{( R )} {N}_{RB}^{( R )} < {N}_{R} ,$$

where

$${N}_{RE}^{( R )}$$

is the number of DMRS RE per PRB used for R_{I+N,i} estimation, and

$${N}_{RB}^{( R )}$$

is the number of PRBs, per which a single R_{I+N,i} estimate is generated and (R_{I+N,i})⁻¹ is performed.
The resulting estimates representing the channel and interference at DMRS REs, which can differ from channel and interference of PUSCH REs.

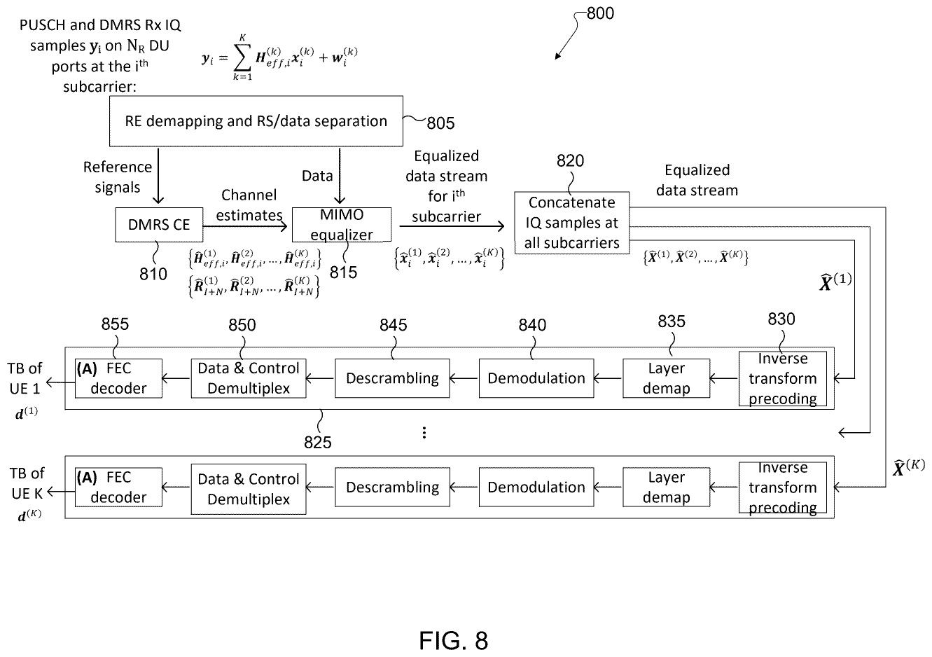

After the MIMO equalization at the BS, the IQ samples at all subcarriers may be concatenated for each user. Estimated data stream of the kth user is denoted as

$${\hat{X}}^{( k )} ∈ {ℂ}^{{N}_{L}^{( k )} \times N} ,$$

where N is the number of samples collected over the transmitted frame. Demodulation and decoding processes may occur separately for each user. Initially, inverse transform precoding may be applied if DFT-s-OFDM is activated for a given user. Then, layer demapping may be followed by demodulation. Descrambling and demultiplexing of data and control bits may prepare the input for an FEC decoder. The output of an FEC decoder may provide TBs of users as illustrated in FIG. 8.

FIG. 8 illustrates an example UL signal processing 800 according to example embodiments of the present disclosure. An embodiment of the example UL signal processing illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of UL signal processing could be used without departing from the scope of this disclosure. The UL signal processing 800 may be performed at an O-DU 510 by a component thereof, e.g., the controller/processor 225 of FIG. 2.

As illustrated in FIG. 8, the UL signal processing 800 may include a demapping and separation operation 805, a DMRS CE operation 810, a MIMO equalization operation 815, a concatenation operation 820, and a demultiplexing and decoding operation 825. When a UL signal (PUSCH and DMRS IQ samples y_i) is received on N_{R} DU ports at the ith subcarrier in the PUSCH allocation, the demapping and separation operation 805 may operate to demap the REs and separate data from RS.

The DMRS CE operation 810 may operate to perform CE utilizing the separated DMRS. The channel estimates may include

$${H}_{eff , i}^{H}$$

### and R_{I+N,i}.

The MIMO equalization operation 815 may operate to receive the channel estimates and the separated data REs (streams) and recover the transmitted data streams Xᵢ. The MIMO equalization operation 815 may separate spatial layers and compensate for channel distortions to equalize Xᵢ.

The concatenation operations 820 may operate to receive the equalized transmitted data streams \hat{X}^{(k)} and concatenate IQ samples (post-equalization) at all subcarriers to output the concatenated data streams (the concatenated frequency-domain symbol vector X\hat{ }\hat{ }((k))) to corresponding layer FEC decoders.

The demultiplexing and decoding operation 825 may operate to demultiplex and decode data per layer and include an inverse transform precoding operation 830, a layer demapping operation 835, a demodulation operation 840, a descrambling operation 845, a data and control demultiplexing operation 850 and an FEC decoding operation 855.

The inverse transform precoding operation 830 may operate to reverse the DFT-spread precoding, if activated for a given UE transmitter, and transform the equalized frequency-domain symbols back to the time domain.

The layer demapping operation 835 may operate to map per-layer symbols back to the logical channels or remove layer-specific precoding.

The demodulation operation 840 may operate to demodulate the demapped time domain symbols and convert these analog symbols to digital bit probabilities (soft bits) for decoding.

The descrambling operation 845 may operate to descramble the soft bits using a known pseudo-random sequence to reverse the bit-level scrambling applied at the UE transmitters. It may restore the original coded bit sequence and output descrambled soft bits.

The data and control demultiplexing operation 850 may operate to separate the descrambled bits into data (TBs) and UCI such as HARQ-ACK and CSI, and thus prepare the input for FEC. This operation may isolate the control information for separate processing.

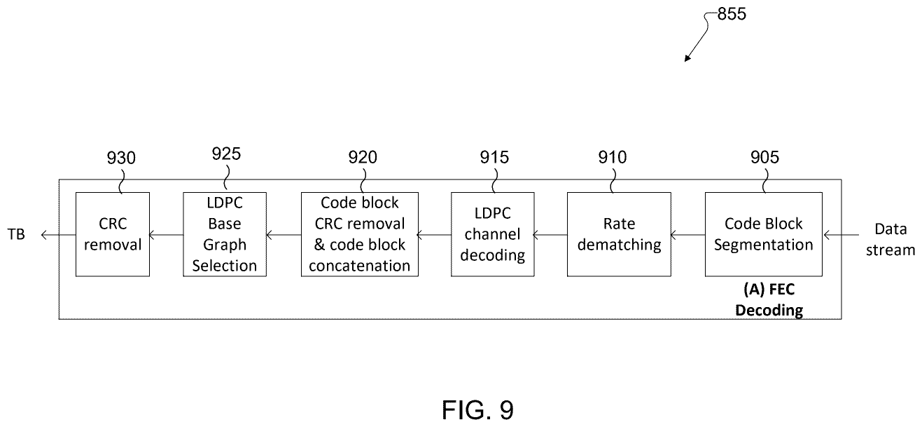

The FEC decoding operation 855 may operate to decode the data to obtain system bits of the TBs and output TBs of corresponding users. The FEC decoding operation 855 is discussed further in detail with reference to FIG. 9. Note that the UL signal processing 800 also performs CE utilizing DMRS symbols, and remain subject to the challenges in dynamic and interference-prone environments due to the limited number of DMRS symbols.

Although FIG. 8 illustrates one example UL signal processing 800, various changes may be made to FIG. 8. For example, various components or functions in FIG. 8 may be combined, further subdivided, replicated, omitted, or rearranged and additional components or functions may be added according to particular needs.

FIG. 9 illustrates an example FEC decoding operation 855 of a demultiplexed uplink data stream according to example embodiments of the present disclosure. An embodiment of the example FEC decoding operation illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of FEC decoding operation could be used without departing from the scope of this disclosure. The FEC decoding operation 855 may be performed at an O-DU 510 by a component thereof, e.g., the controller/processor 225 of FIG. 2.

As illustrated in FIG. 9, the FEC decoding operation 855 may decode the demultiplexed soft bits and include a segmentation operation 905, a rate dematching operation 910, a channel decoding operation 915, a concatenation operation 920, a selection operation 925, and a cyclic redundancy check (CRC) removal operation 930.

The segmentation operation 905 may operate to segment demultiplexed data stream into individual code blocks (CBs) and output separate soft bit streams for each CB.

The rate dematching operation 910 may operate to reverse the rate matching applied at UE transmitters and adjust the coded CB size to fit the allocated resources. This may include the processor 225 to insert zeros and combine duplicates. The rate dematching operation 910 may output full-sized coded CB LLRs.

The channel decoding operation 915 may operate to apply low-density parity-check (LDPC) decoding to each CB's LLRs and output decoded CB bits.

The concatenation operation 920 may operate to check (e.g., a 24-bit CB CRC) and remove a CRC upon passing the check. It may concatenate the CBs to discard filler bits to generate TBs using only the CBs that have passed CRC check.

The selection operation 925 may operate to select an LDPC base graph based on the effective code rate. The selection may be made per CB and resource allocation. This operation may optimize decoding complexity and performance by, e.g., selecting a low effective code rate base graph for channel aging.

The CRC removal operation 930 may operate to remove a CRC at the TB level. This operation may include the processor 225 performing, e.g., a 24-bit TB CRC check and remove the CRC upon passing the check. If the CRC fails, the TB in its entirety may be discarded. Upon the CRC removal, decoded TB for users may be output.

Although FIG. 9 illustrates one example FEC decoding operation 855, various changes may be made to FIG. 9. For example, various components or functions in FIG. 9 may be combined, further subdivided, replicated, omitted, or rearranged and additional components or functions may be added according to particular needs.

As previously mentioned, the UL signal processing 600, 800 face challenges in dynamic and interference-prone environments due to the limited DMRS density when performing CE utilizing only the DMRS. The embodiments of the present disclosure, however, allow DDCE to be performed at the RIC 502, 504, thereby leveraging the decoded data from PUSCH as an additional source to refine the channel estimate and interference and noise covariance matrix estimation beyond the DMRS symbols. Note that DDCE refers to a channel estimation technique to refine the estimate of the radio channel's response by leveraging decoded data symbols as pseudo-pilots in addition to known reference signals such as DMRS or phase tracking reference signal (PTRS). Unlike the pilot-based CE, which relies solely on known pilot signals, DDCE utilizes decisions made on received data symbols to improve estimation accuracy.

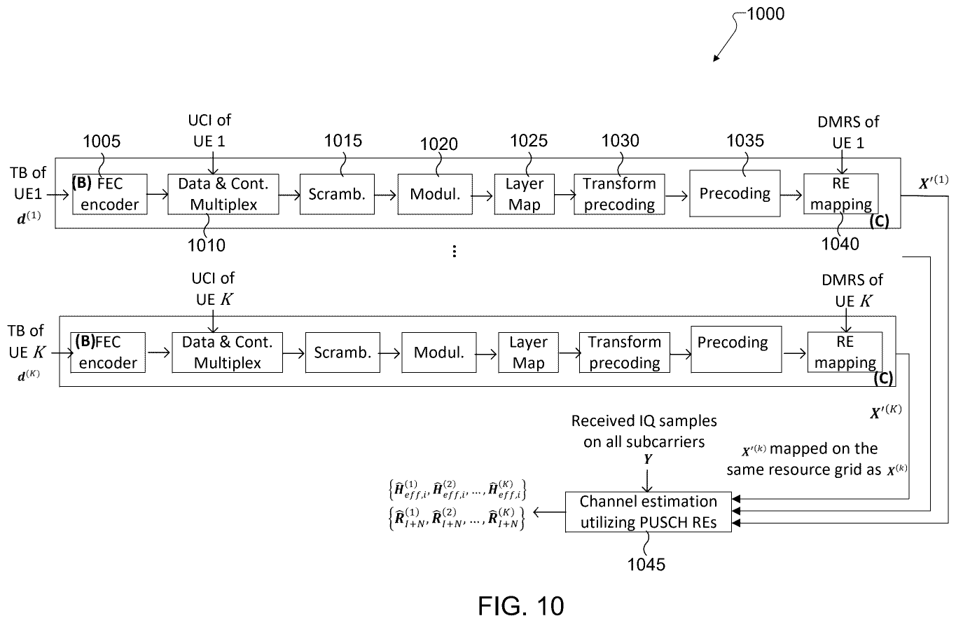

The embodiments also introduce a signaling mechanism for transferring received IQ samples, TB, and UL scheduling related IEs from the O-DU 510 to the RIC 502, 504, allowing dedicated AI/ML algorithms for DDCE in the RIC to enhance channel and covariance matrix estimates. To perform DDCE, data streams of users may need to be reconstructed at the RIC 502, 504 from TBs of users following reverse operations as illustrated in FIG. 10.

FIG. 10 illustrates an example reconstruction 1000 of UL data streams for AI-based DDCE according to example embodiments of the present disclosure. An embodiment of the example reconstruction illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of reconstruction of UL data streams could be used without departing from the scope of this disclosure. The reconstruction 1000 may be performed at an O-DU 510 by a component thereof, e.g., the controller/processor 225 of FIG. 2.

The example reconstruction 1000 may be performed by applying a reverse process to the UL signal processing 600, 800. It may include an encoding operation 1005, a multiplexing operation 1010, a scrambling operation 1015, a modulation operation 1020, a layer mapping operation 1025, a transform precoding operation 1030, a precoding operation 1035, an RE mapping operation 1040 and a CE operation 1045.

The FEC encoding operation 1005 may operate to receive a TB of a UE and perform FEC encoding. The multiplexing operation 1010 may operate to receive the encoded TB and multiplex the concatenated data with UCI, thereby reversing the demultiplexing operation (e.g., demultiplexing operation 850).

The scrambling operation 1015 may operate to receive and scramble the multiplexed bit stream with a pseudo-random sequence to randomize inter-UE interference and spectral shaping. This operation reverses the descrambling operation (e.g., descrambling operation 845). The modulation operation 1020 may operate to receive the scrambled bit stream and group the scrambled bits into symbols and modulate the symbols, reversing the demodulation operation (e.g., demodulation operation 840).

The layer mapping operation 1025 may operate to map the modulated symbols to spatial layers, thereby reversing the demapping (e.g., layer demapping 835). The transform precoding operation 1030 may operate to perform DFT to spread across subcarriers and reduce PAPR (peak-to-average power ratio), if applicable.

The precoding operation 1035 may operate to precode the modulated symbols across antenna ports based on TPMI and output precoded symbols per port. The RE mapping operation 1040 may operate to map the per-port precoded symbols to scheduled REs. This operation may output frequency-domain symbols

$${X}_{k}^{′} .$$

The CE operation 1045 may operate to perform channel estimation utilizing the received IQ samples on all subcarriers Y and mapped symbols

$${X}_{k}^{′} .$$

Applying algorithms such as least square (LS) or minimum mean square (MMSE), channel estimates

$${\hat{H}}_{eff , i}^{( k )}$$

can be estimated. After subtracting the known signal

$${\sum }_{k = 1}^{K} = {\hat{H}}_{eff , i}^{( k )} {x}_{i}^{( k )}$$

from the received signal yᵢ, the interference and noise covariance matrix estimate \hat{R}_{I+N,i} can be obtained.

Although FIG. 10 illustrates one example reconstruction 1000 of UL transmitted data for AI-based DDCE, various changes may be made to FIG. 10. For example, various components or functions in FIG. 10 may be combined, further subdivided, replicated, omitted, or rearranged and additional components or functions may be added according to particular needs.

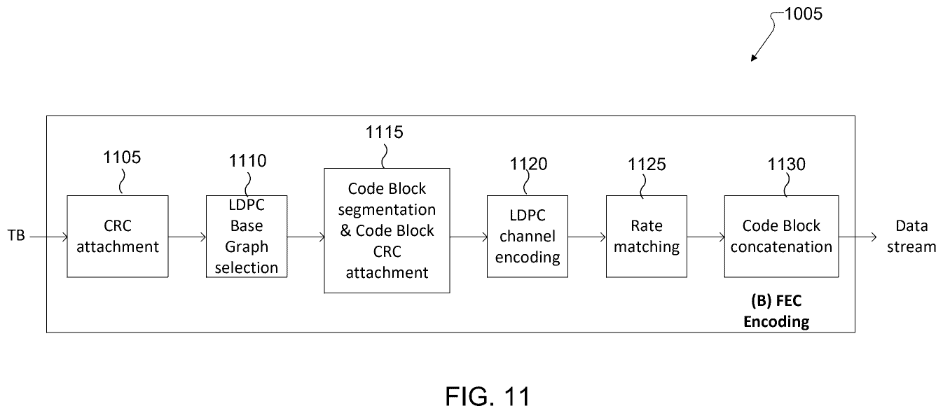

FIG. 11 illustrates an example FEC encoding operation 1005 of the decoded UL data streams according to example embodiments of the present disclosure. An embodiment of the example FEC encoding 1005 illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of FEC encoding could be used without departing from the scope of this disclosure.

The FEC encoding operation 1005 may utilize the LDPC coding. To reconstruct, an LDPC base graph selection operation 1110 may be performed using a combination of the coding rate and a TB size threshold. The combination of TB and CRC bits may be segmented if necessary. Interleaving and/or de-interleaving process may be defined in standards where the rate-matched bits from the circular buffer are written in a row-first order into another buffer and read in a column-first order.

As shown in the example embodiment of FIG. 11, the FEC encoding operation 1005 may include an attachment operation 1105, a selection operation 1110, a segmentation and attachment operation 1115, an LDPC channel encoding operation 1120, a rate matching operation 1125, and a CB concatenation operation 1130.

The attachment operation 1105 may operate to receive a TB of a UE and attach a CRC to the TB for an error detection. The selection operation 1110 may operate to select an LDPC base graph based on an effective code rate for the TB, which may be derived from a modulation and coding scheme (MCS) index in a DCI or an MCS table in PUSCH-Config. The selected base graph may define a parity-check matrix and encoding parameters.

The segmentation and attachment operation 1115 may operate to segment the TB into multiple CBs and attach a CB CRC to each CB. This operation may allow parallel encoding of large TBs and per-CB error detection. The LDPC channel encoding operation 1120 may operate to encode each CB utilizing the selected base graph's LDPC code and generate parity bits. This operation may add redundancy for error correction and increase robustness to channel effects such as noise from covariance singularity or aging.

The rate matching operation 1125 may operate to receive and adjust the coded CBs to match the allocated PUSCH resources, e.g., via puncturing or duplication. This operation may ensure that the coded bits fit the channel capacity. The CB concatenation operation 1130 may operate to concatenate the rate-matched CBs in order and output concatenated data stream.

Although FIG. 11 illustrates one the FEC encoding operation 1005, various changes may be made to FIG. 11. For example, various components or functions in FIG. 11 may be combined, further subdivided, replicated, omitted, or rearranged and additional components or functions may be added according to particular needs.

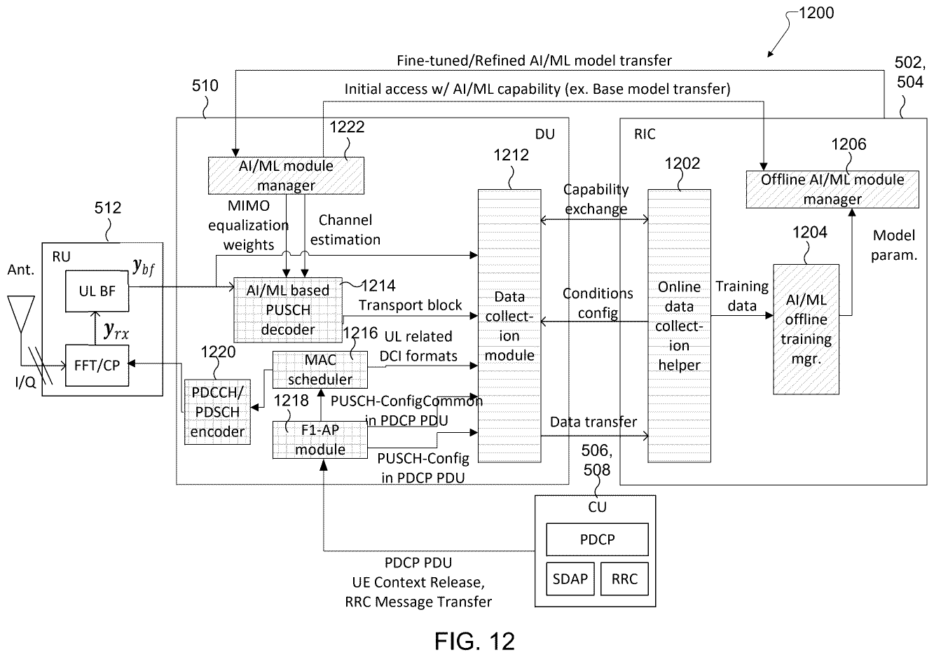

FIG. 12 illustrates an example AI-based DDCE framework 1200 according to example embodiments of the present disclosure. An embodiment of the example framework illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of the AI-based DDCE framework could be used without departing from the scope of this disclosure.

The example framework 1200 may include signaling between an RIC 502, 504 and O-DU entities 510 in the network. As shown in FIG. 12, the RIC 502 and 504 may include an online data collection helper 1202, an AI/ML offline training manager 1204, and an offline AI/ML module manager 1206. The O-DU 510 may include a data collection module 1212, an AI/ML based PUSCH decoder 1214, a MAC scheduler 1216, an F1-AP module 1218, a PDCCH/PDSCH encoder 1220, and a target AI/ML module manager 1222. Optionally, the framework 1200 may include an O-CU 506, 508 connected to the F1-AP module 1218 to transmit a PDCP PDU, UE context release, and an RRC message.

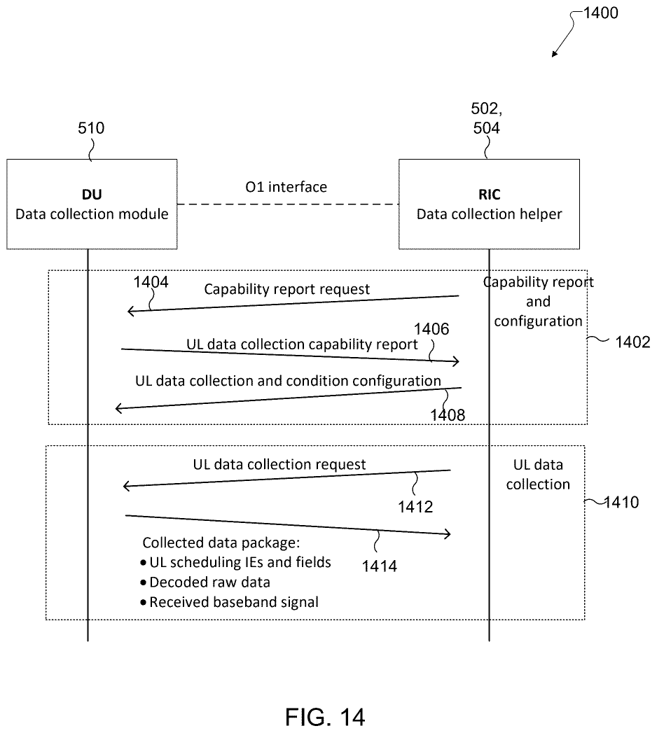

The online data collection helper 1202 may be communicatively connected to the data collection module 1212, transmit a UL data collection capability request to the O-DU 510, generate a data collection request, and configure a data collection and condition configuration. The data collection and condition configuration may include, for example, a collection time window and a set of data collection conditions. The capability exchange, condition configuration, and data transfer are discussed further in detail with reference to FIGS. 14-19D.

The AI/ML offline training manager 1204 may perform on-demand model fine-tuning and retraining of offline AI models and control the training dataset generation and the offline AI/ML module manager 1206. It may configure a training (fine-tuning, refining and/or retraining) strategy for target AI models. It may also evaluate the target AI models and generate model update demands. The AI/ML offline training manager 1204 may train offline AI/ML models using decision directed channel estimates made at the RIC 502, 504 with the reconstructed UL data. In one embodiment, one or more fine-tuned, refined and/or retrained offline models (versions) may be transferred to the offline AI/ML module manager 1206 and then to the target AI/ML module manager 1222 in the O-DU 510 to update the target AI/ML models.

The data collection module 1212 in the O-DU 510 may collect:
Received signal y_{bf}, which is the output of an O-RU 512
TB, which is the output of an AI/ML based PUSCH decoder 1214
UL related DCI formats from the MAC scheduler 1216
Information elements in PUSCH-Config, which is obtained from the F1-AP module 1218.

The PDCCH/PDSCH encoder 1220 may be connected to the MAC scheduler 1216 and the O-RU 512 for transferring UL related scheduling data.

The O-DU 510 may transfer TBs of UEs and PUSCH IQ samples at DU ports on the scheduled REs to the RIC 502, 504.

The data collection module 1212 may be configured to control the data collection, and examine one or more specific data collection conditions. The data collection module 1212 may receive a UL data collection capability request, a data collection condition configuration, and a data collection request from the data collection helper 1202. In response to the UL data collection capability request, the data collection module 1212 may transmit its UL data collection capability report. In response to the data collection request, the data collection module 1212 may transfer the TBs of UEs and PUSCH IQ samples to the data collection helper 1202.

The target AI/ML module manager 1222 may be disposed in the O-RU 512 or O-DU 510 and control, e.g., module registration, base model transfer, base model training set transfer, base model training hyper parameter transfer, etc. The target AI/ML module manager 1222 may also control the application of the weights of a target AI/ML model when a fine-tuned or refined AI/ML model is ready.

In some embodiment, UL related parameters configured via RRC may be directly sent to the RIC 502, 504 from an O-CU 506, 508 through the O1 interface.

Although FIG. 12 illustrates one example AI-based DDCE framework 1200, various changes may be made to FIG. 12. For example, various components or functions in FIG. 12 may be combined, further subdivided, replicated, omitted, or rearranged and additional components or functions may be added according to particular needs.

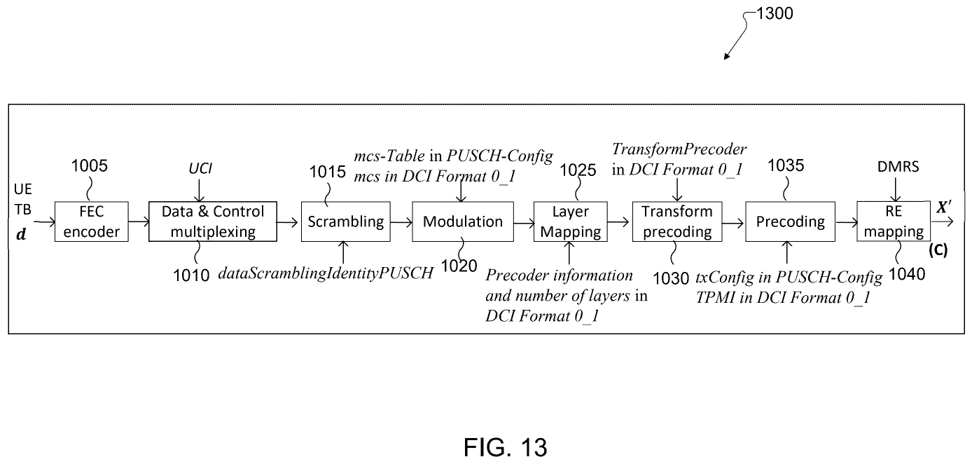

FIG. 13 illustrates an example reconstruction 1300 of a UL signal at an RIC 502, 504 according to embodiments of the present disclosure. An embodiment of the example reconstruction illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of reconstruction could be used without departing from the scope of this disclosure. The example reconstruction 1300 is similar to the reconstruction 1000 of FIG. 10.

The example reconstruction 1300 shown in FIG. 13 may include the FEC encoding operation 1005, the data and control multiplexing operation 1010, the scrambling operation 1015, the modulation operation 1020, the layer mapping operation 1025, the transform precoding operation 1030, the precoding operation 1035 and the RE remapping operation 1040.

The RIC 502, 504 may reconstruct the PUSCH signal from TB data and estimate the kth UE channel Ĥ^{(k)} and \hat{R}_{I+N}. Additionally, the UCI and DMRS of UEs may be transferred to the RIC 502, 504 to perform the reconstruction. For example, to perform the scrambling operation 1015, the RIC 502, 504 may utilize dataScramblingldentityPUSCH IE, if configured in PUSCH-Config, or based on the physical cell ID, otherwise. The modulation operation 1020 may operate to modulate the scrambled data bits utilizing, e.g., the mcs-Table in the PUSCH-Config and mcs in DCI format 0_1. The layer mapping operation 1025 may operate to map the modulated data bits utilizing, e.g., precoder information and number of layers in the DCI format 0_1. The transform precoding operation 1030 may operate to precode the mapped data bits utilizing, e.g., TransformPrecoder in the DCI format 0_1. The precoding operation 1035 may operate to precode the coded data bits utilizing, e.g., txConfig in the PUSCH-Config and TPMI in the DCI format 0_1.

Although FIG. 13 illustrates one example reconstruction 1300 of a UL signal at an RIC 502, 504, various changes may be made to FIG. 13. For example, various components or functions in FIG. 13 may be combined, further subdivided, replicated, omitted, or rearranged and additional components or functions may be added according to particular needs.

FIG. 14 illustrates an example signaling 1400 for UL data collection between an RIC 502, 504 and an O-DU 510 according to embodiments of the present disclosure. An embodiment of the example signaling illustrated in FIG. 14 is for illustration only. Other signaling embodiments could be used without departing from the scope of this disclosure.

UL data collection may be managed in the RIC 502, 504 by initially asking a UL data collection capability report from an O-DU 510, sending a data collection configuration and a data collection request for UL data from the data collection module 1212 in an O-DU 510 and/or an O-RU 512. The communications between an RIC 502, 504 and the O-DU 510/O-RU 512 may be facilitated by an O1 interface or an open fronthaul M-plane.

The UL related data collection in the O-DU 510 may be controlled by a data collection helper (e.g., the online data collection helper 1202 of FIG. 12) located in the RIC 502, 504. A set of condition may be configured by the data collection helper 1202 in the RIC 502, 504. Parameters to be asked by the RIC 502 and 504 may be set during the capability exchange while configuring the data collection.

As shown in FIG. 14, the data collection may include a capability report and configuration process 1402 and a data collection process 1410. The capability report and the configuration process 1402 may include a capability report request operation 1404, a capability report operation 1406, and a data collection and condition configuration operation 1408.

The capability report request operation 1404 may operate to transmit a capability report request to the O-DU 510. This may include the online data collection helper 1202 of the RIC 502, 504 transmitting a capability exchange request to a data collection module (e.g., the data collection module 1212 of FIG. 12) in the O-DU 510 for UL data collection.

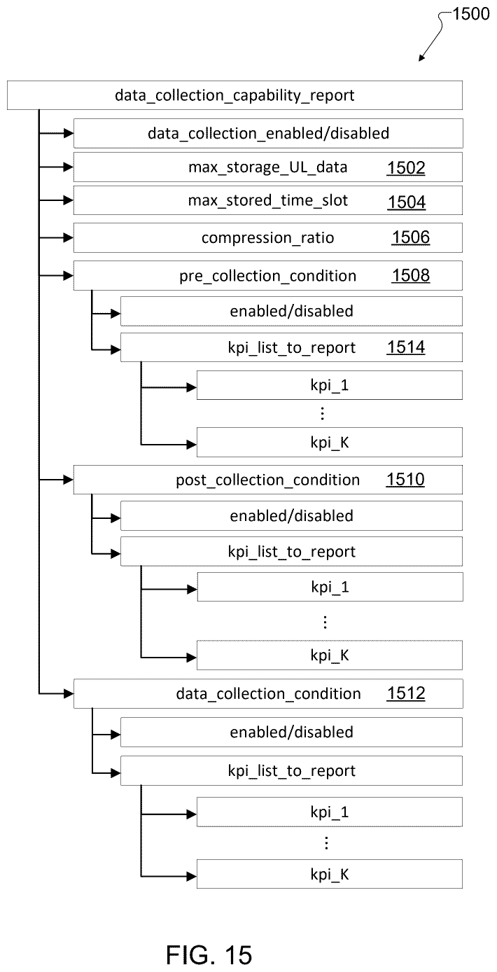

The capability report operation 1406 may operate to transmit a UL data collection capability report to the RIC 502, 504. This may include the data collection module 1212 transmitting the UL data collection capability report to the online data collection helper 1202 of the RIC 502, 504. This operation is discussed further in detail with reference to FIG. 15.

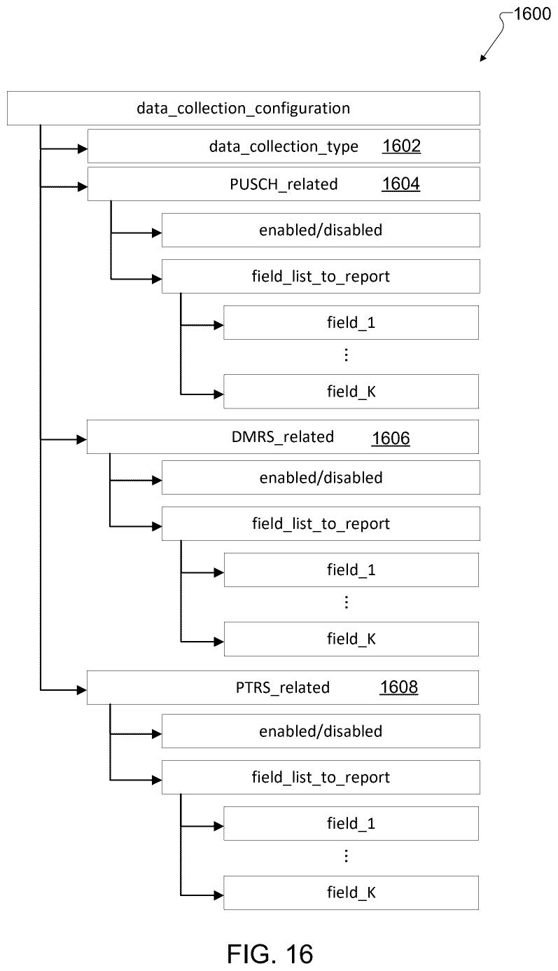

The data collection and condition configuration operation 1408 may operate to transmit a UL data collection and condition configuration to the RIC 502, 504. This may include the data collection helper 1202 transmitting the UL data collection and condition configuration to the data collection module 1212 of the O-DU 510 for UL data collection. This operation is discussed further in detail with reference to FIGS. 16-19.

The data collection process 1410 may include an UL data collection request operation 1412 and a UL data collection and transfer operation 1414. The UL data collection request operation 1412 may operate to transmit an UL data collection request to an O-DU 510. This may include the RIC 502, 504 generating and transmitting the UL data collection request to the O-DU 510 based on the UL data collection capability report. The UL data collection and transfer operation 1414 may operate to collect and transmit UL data to the RIC 502, 504. This may include the O-DU 510 processing a data collection request configured by the data collection helper 1202 in the RIC 502, 504 and collecting the requested data based on the UL data collection and condition configuration and the UL data collection request.

The data collection module 1212 in the O-DU 510 may collect configured data types when a configured condition is satisfied. The data collection module 1212 may filter the collected data samples based on a data request condition. The data collection module 1212 may deliver and transfer the data packages to the data collection helper 1202 in the RIC 502, 504.

When the data collection is terminated, the data collection module 1212 may pack the selected data samples into a package, and transfer the package to the data collection helper 1202. The package may be transferred through an open fronthaul M-plane or an O1 interface.

The data collection module 1212 may transfer the UL data package stored in the memory to the data collection helper 1202 in the RIC 502, 504. The package may be transferred in several ways. In one embodiment, the data package may be transferred to the data collection helper 1202 once data sample is received. In an alternative embodiment, the UL data package may be transferred to the data collection helper 1202 when the buffer reaches a certain condition (e.g., the memory (the buffer) is full).

The data collection helper 1202 may receive and store the collected data (the package) in memory. The collected UL data may be packaged in different ways based on the configuration instructed by the data collection helper 1202 in the RIC 502, 504.

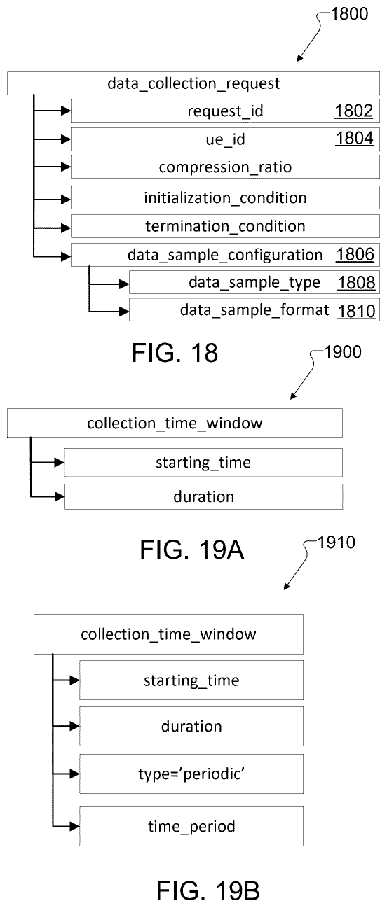

In one embodiment, the collected data may be directly stored in the memory. In an alternative embodiment, the collected data may be unpacked and reconstructed to a certain format and then stored in the memory. In another alternative embodiment, the received collected data may be filtered before storing in the memory. For example, an outlier detection may be applied to remove a corrupted data. In another alternative embodiment, the UL data package may be selectively constructed according to a configured data sample format as shown in FIG. 18.

When the data collection is terminated, the termination of the data collection may be indicated in several ways. In one embodiment, if the O-DU 510 cannot correctly decode the PUSCH data, the O-DU 510 may ask the UE for retransmission through DCI 0_0/0_1 with the NDI toggled. In such a scenario, an automatic signaling may be sent to the RIC 502 and 504 from the O-DU 510 to indicate that the PUSCH data may not be stored due to an incorrect decoding. In another embodiment, if the end of a configured collection time window is reached, the data collection may be terminated. In another embodiment, if a certain number of PUSCH samples is collected in accordance with a condition(s), the data collection may be terminated. The data collection may also be terminated when the maximum available memory is reached for the UL data collection.

Although FIG. 14 illustrates one example signaling 1400 for UL data collection, various changes may be made to FIG. 14. For example, various operations or functions in FIG. 14 may be combined, further subdivided, replicated, omitted, or rearranged and additional operations or functions may be added according to particular needs.

FIG. 15 illustrates an example data collection capability report 1500 from an O-DU 510 for UL data collection according to embodiments of the present disclosure. An embodiment of the example data collection capability report illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a data collection capability report could be used without departing from the scope of this disclosure.

The UL data collection capability report may be signaled from an O-DU 510 to a RIC 502, 504 to inform capabilities of the O-DU 510. As shown in FIG. 15, a UL data collection capability report may include the following IEs/fields:
max_storage_UL_data field 1502, which reports maximum possible storage capability for UL related data.
max_stored_time_slot field 1504, which reports how many time slots of UL data can be stored.
compression_ratio field 1506, which reports whether compression to the stored data is applicable or not.
pre_collection_condition field 1508, post_collection_condition field 1510, data_collection_condition field 1512, which report the support for corresponding condition evaluators.
kpi_list_to_report field 1514, which reports a list of KPIs that can be evaluated for each supported condition evaluator.

In one embodiment, the support of each condition evaluator (e.g., a pre-collection condition evaluator, a post-collection condition evaluator, and a data collection condition evaluator) may be indicated by a field as disabled or enabled. The condition evaluators may be included in the O-DU 510. A pre-collection condition evaluator may monitor a pre-collection condition (e.g., SINR<5 dB) configured by the data collection helper 1202 in the RIC 502, 504. Such condition may be evaluated in the O-DU 510 before the UL data collection starts. If the pre-collection condition is satisfied, the pre-collection condition evaluator may trigger the UL data collection process. The pre-collection condition evaluator may be expected to exist in order to trigger the data collection.

A post-collection condition evaluator may monitor a post-collection condition (e.g., a number of SINR<5 dB to be collected) configured by the data collection helper 1202. Such condition may be evaluated after the data collection. If the post-collection condition is satisfied, the collected data may be forwarded for further evaluation.

A data sample evaluator may evaluate the received UL data further regarding the configured conditions. Conditions may be exemplified as, e.g., an SINR threshold, BLER threshold, etc. If the condition is satisfied, the UL data may be stored in the buffer of the O-DU 510.

In one embodiment, the KPIs may be specified in a standard specification. The specified name of the KPI may be included in the UL data collection capability report.

Although FIG. 15 illustrates one example data collection capability report 1500, various changes may be made to FIG. 15. For example, various components or functions in FIG. 15 may be combined, further subdivided, replicated, omitted, or rearranged and additional components or functions may be added according to particular needs.

FIG. 16 illustrates an example UL data collection and condition configuration 1600 according to embodiments of the present disclosure. An embodiment of the example UL data collection and condition configuration illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of UL data collection and condition configuration could be used without departing from the scope of this disclosure.

The UL data collection and condition configuration may be signaled from an RIC 502, 504 to an O-DU 510 to configure data collection conditions and information elements and/or fields for the DDCE operation at the RIC 502, 504. The data collection helper 1202 in the RIC 502, 504 may configure the data collection module 1212, which manages a target AI module. The UL data collection and condition configuration may include a collection time window, a set of data collection conditions, and a configuration for when to delete the stored data for clearing the buffer in the O-DU 510. Each data collection condition may include a condition expression for data samples and a minimum number of the data samples to be included in the requested data collection package.

The example UL data collection and condition configuration shown in FIG. 16 may include a data_collection_type field 1602, a PUSCH_related field 1604, a DMRS_related field 1606, and a PTRS_related field 1608.

The data_collection_type field 1602 may configure the activation and/or deactivation type of data collection in the O-DU 510. Several options may be available for this field:
proactive: This option may configure the O-DU 510 to collect all possible UL related data even though a data collection request may not have been sent by the RIC 502, 504. In this option, a data buffer in the data collection module 1212 may be cleared as soon as the buffer becomes full.
on_demand: This option may configure the O-DU 510 to wait for a data collection request from the RIC 502, 504 in order to collect the data. The data collection request may configure data collection parameters, e.g., a collection time window, stopping criteria, etc.

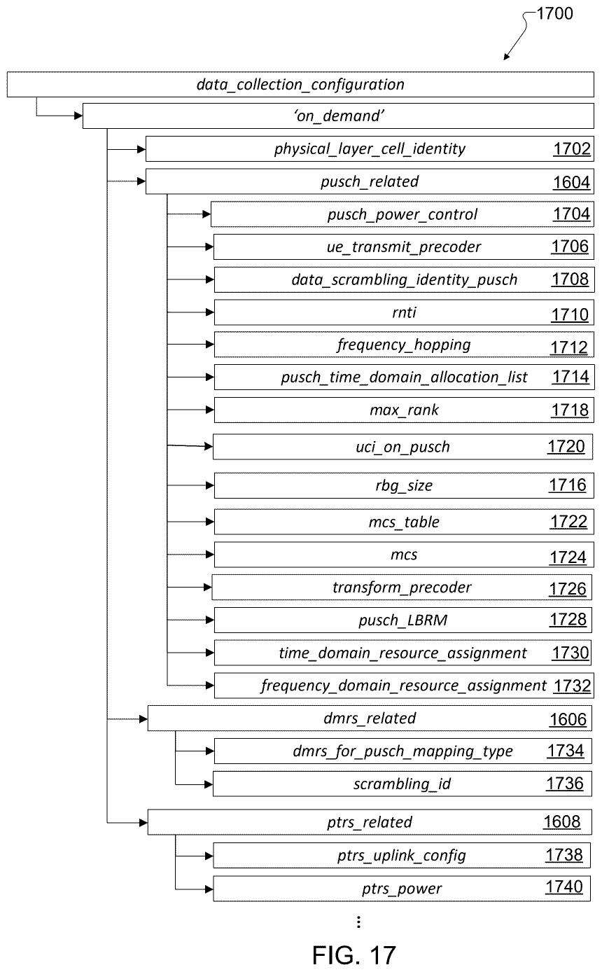

One or more parameters may be used re-encode the data bit streams into modulation symbols and map these modulation symbols to the OFDM resource grid. The RIC 502 and 504 may command the O-DU 510 to store these parameters together with data streams. An example of a data_collection_configuration signaling for UL data collection is illustrated in FIG. 17.

Although FIG. 16 illustrates one UL data collection and condition configuration 1600, various changes may be made to FIG. 16. For example, various components or functions in FIG. 16 may be combined, further subdivided, replicated, omitted, or rearranged and additional components or functions may be added according to particular needs.

FIG. 17 illustrates an example on-demand data collection configuration 1700 signaled from an RIC 502, 504 according to embodiments of the present disclosure. An embodiment of the example on-demand data collection configuration 1700 illustrated in FIG. 17 is for illustration only. One or more of the components illustrated in FIG. 17 may be implemented in specialized circuitry configured to perform the noted functions or one or more of the components may be implemented by one or more processors executing instructions to perform the noted functions. Other embodiments of on-demand data collection configuration could be used without departing from the scope of this disclosure.

The example data_collection_configuration signaling of FIG. 17 may include the parameters for re-encoding (reconstructing) the data bit streams into modulation symbols and map these modulation symbols to the OFDM resource grid. These parameters may include a physical_layer_cell_identity field 1702, a PUSCH_related field 1604, a DMRS_related field 1606, and a PTRS_related field 1608.

The physical_layer_cell_identity field 1702 may be used to regenerate a Zadoff-Chu sequence for DMRS and initialize a pseudo random sequence that scrambles the PUSCH data.

The fields related to PUSCH (pusch_related) may be utilized to configure the UE specific PUSCH parameters applicable to a particular BWP:
pusch_power_control field 1704: This field may include power control parameters of PUSCH transmission.
ue_transmit_precoder field 1706: If the UE precoding is activated via txConfig IE in PUSCH-Config, TPMI value may be included during the UL data collection in order to regenerate the UL signal from the data bits at the RIC 502, 504.
data_scrambling_identity_pusch field 1708: This field can be utilized to initialize the pseudo random sequence that scrambles the PUSCH data prior to modulation.
rnti field 1710: C-RNTI may be utilized to initialize the pseudo random sequence that scrambles the PUSCH data.
frequency_hopping field 1712: If frequency hopping is enabled for PUSCH, the frequency hopping pattern may be reported to the RIC 502, 504.
pusch_time_domain_allocation_list field 1714: This field may determine the time domain resource allocation of PUSCH. This IE may be known to the RIC 502, 504 in order to perform the reconstruction operation needed for the DDCE.
rbg_size field 1716: The number of RBs allocated for PUSCH transmission within RBG depends on the BWP size and ‘rbg-size’ IE. Therefore, the RIC 502 and 505 may be informed by the rbg_size IE.
max_rank field 1718: The number of UL transmission layers may be known to the RIC 502, 504 in order to perform correct layer mapping during the reconstruction of the UL stream.
uci_on_pusch field 1720: This IE may instruct the number of resource elements allocated to UCI, which is multiplexed onto the PUSCH. The RIC 502 and 504 can also operate on these resource elements to improve UL channel estimation performance.
mcs_table field 1722: It may be important to know which MCS Table is used from the standards in modulation for reconstruction process.
mcs field 1724: MCS level may be known to the RIC 502, 504 in order to perform reconstruction successfully.
transform_precoder field 1726: The UL waveform may be utilized by the RIC 502, 504 for the reconstruction process. This IE may instruct which waveform type is used, for example, DFT-s-OFDM or CP-OFDM.
pusch_LBRM field 1728: In case of a limited buffer rate matching (LBRM) use in the UE for rate matching, the BS may store the UE capability signal pusch-LBRM IE. It may be in Phy-ParametersFRX-Diff. If the UE supports LBRM, the BS can provide the instruction to use LBRM within the PUSCH-ServingCellConfig. The starting point of circular buffer may depend on a redundancy version (RV). In the case of dynamic resource allocations, the RV may be indicated within the DCI. In the case of configured grants, RV patterns can be specified for autonomous transmission repetitions. These patterns may be specified using the repK-RV IE.
time_domain_resource_assignment field 1730: This IE may point a row of the look-up table for time-domain resources.
frequency_domain_resource_assignment field 1732: This IE may be utilized to specify the set of allocated RBs.

The fields related to DMRS (dmrs_related) may be utilized to configure an uplink DMRS for PUSCH, and include:
dmrs_for_pusch_mapping_type field 1734: This field may indicate which OFDM symbols are used for the DMRS transmission.
scrambling_id field 1736: This IE may be known to regenerate Zadoff-Chu sequence for the DMRS.

The fields related to PTRS (ptrs_related) may include:
ptrs_uplink_config field 1738: PTRS power can be different than PUSCH.
ptrs-Power field 1740 in PTRS-UplinkConfig may configure PTRS power.

Although FIG. 17 illustrates one example on-demand data collection configuration 1700, various changes may be made to FIG. 17. For example, various components or functions in FIG. 17 may be combined, further subdivided, replicated, omitted, or rearranged and additional components or functions may be added according to particular needs.

FIG. 18 illustrates an example data collection request 1800 from an RIC 502, 504 according to embodiments of the present disclosure. An embodiment of the example data collection request illustrated in FIG. 18 is for illustration only. One or more of the components illustrated in FIG. 18 may be implemented in specialized circuitry configured to perform the noted functions or one or more of the components may be implemented by one or more processors executing instructions to perform the noted functions. Other embodiments of reconstruction could be used without departing from the scope of this disclosure.

As shown in FIG. 18, each data collection request may have a request_id field 1802 distinguishing the request from other data collection requests. The request_id field 1802 may be utilized in a data collection report transmitted from the data collection module 1212 in the O-DU 510 to the data collection helper 1202 in the RIC 502, 504. A ue_id field 1804 may be utilized to distinguish the scheduled users in the UL transmission slot and data collection duration. The data collection request may also include configurations for initialization condition, termination condition, and triggering condition. It may also include a configuration for the content and format of the data collection. The initialization condition of the data collection may be configured by the online data collection helper 1202 in the RIC 502, 504.

The data collection helper 1202 may also configure the components of the data collection via a data_sample_configuration field 1806. The data collection helper 1202 may configure one or multiple data_sample_type fields 1808 as follows:
input: AI/ML based PUSCH decoder input data
output: AI/ML based PUSCH decoder output data
ground_truth: (pseudo) ground truth data
measurements: KPI with index and measured values, e.g., SNR, interference plus noise power, timing advance, frequency offset, etc.
scheduling: contextual information related to the collected data sample, e.g., timing information (such as a frame index, slot index, time stamp), a number of configured MIMO users, MCS, etc.
IEs_Fields: related IE and fields from PDSCH and PDCCH to schedule uplink data.

The data collection helper 1202 may also configure the format of the data collection via a data_samplejormat field 1810. Alternatives may include:
list: the collected components may be a list in a given sequence in the data package.
group: raw data, received IQ samples and information elements may be grouped separately.

Although FIG. 18 illustrates one example data collection request 1800 for AI-based DDCE, various changes may be made to FIG. 18. For example, various components or functions in FIG. 18 may be combined, further subdivided, replicated, omitted, or rearranged and additional components or functions may be added according to particular needs.

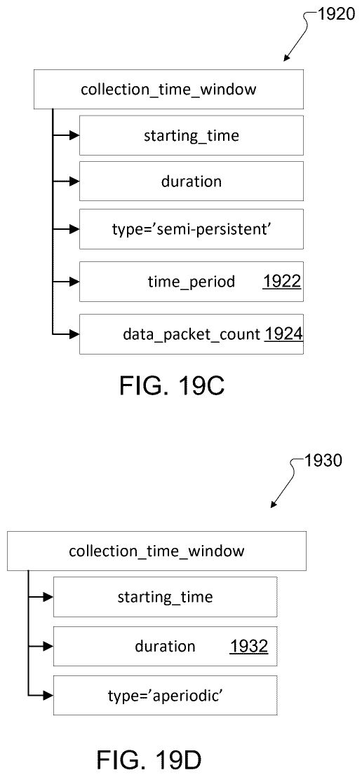

FIGS. 19A-19D illustrate example collection time windows 1900, 1910, 1920, 1930 for a data collection request (e.g., the data collection request 1800 of FIG. 18) according to embodiments of the present disclosure.

FIG. 19A illustrates an example collection time window 1900 that configures the start and the end of the data collection. If, during the collection time window, the number of requested UL related data samples configured by the collection condition list is reached already, the data collection may be terminated. If the collection time window ends, even if the collection condition list has not been accomplished, the data collection may be terminated.

In one embodiment, only a collection duration may be specified without a starting time. This may indicate that the data collection can start the data collection once the data collection request is received. In an alternative embodiment, each data collection request may include a single collection time window. The collection time window configuration may include both a starting time and a duration.

Each data collection request may include one or multiple periodic time windows. For example, the periodicity type may be configured as periodic, semi-persistent, or aperiodic.

FIG. 19B illustrates an example periodic collection time window 1910, which may repeat in a configured period.

FIG. 19C illustrates an example collection time window 1920 having a semi-persistent periodicity. The collection time window 1920 may repeat in a configured period. In this example, the RIC 502, 504 can directly configure a time_period field 1922 in order to dynamically adapt the data collection process. Additionally, a data_package_count field 1924 may be adaptable via the RIC 502, 504 in order to limit the number of data packages collected.

FIG. 19D illustrates an example aperiodic collection time window 1930, which includes only one-shot data package collection. This configuration may include a time duration (a duration field 1932) for data package collection.

Although FIGS. 19A-D show four example collection time windows 1900, 1910, 1920, 1930 for AI-based DDCE, these are for illustrative purposes only, and thus various changes may be made to FIGS. 19A-D without departing from the scope of the present disclosure.

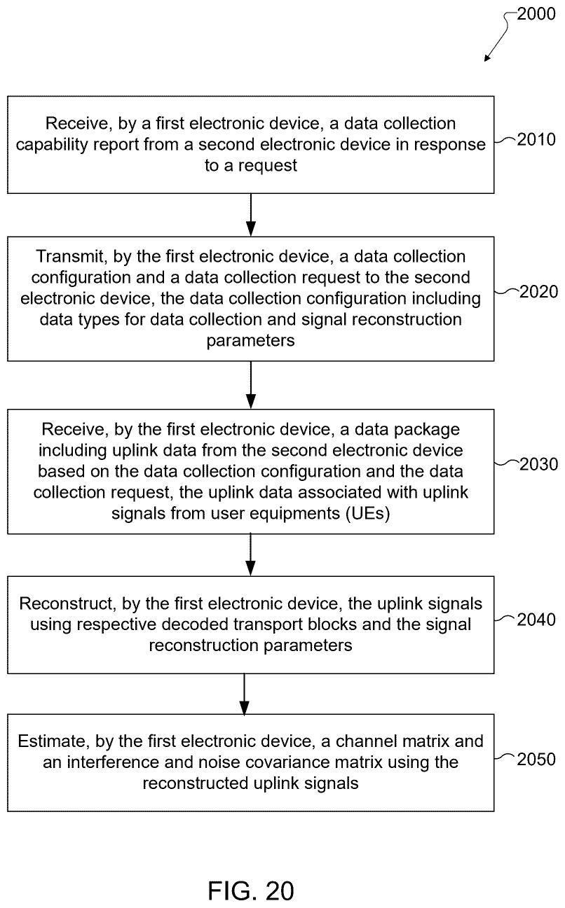

FIG. 20 illustrates an example flow chart for an AI-based DDCE method 2000 according to embodiments of the present disclosure. An embodiment of the method illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments of data preparation could be used without departing from the scope of this disclosure.

As illustrated in FIG. 20, the method 2000 begins at step 2010. At step 2010, a first electronic device (e.g., an RIC 502, 504 of FIG. 5) may receive a data collection capability report from a second electronic device (e.g., an O-DU 512 in FIG. 5) in response to a request. The data collection capability report may include storage capacity of the second electronic device, one or more support indicators associated with one or more condition evaluators, and key performance indicators that the one or more condition evaluators are capable of evaluating.

At step 2020, the first electronic device may transmit a data collection configuration and a data collection request to the second electronic device, the data collection configuration including data types for data collection and signal reconstruction parameters. The data types may include a PUSCH related data type, a DMRS related data type, and a phase tracking reference signal related data type. The signal reconstruction parameters may include at least a UE transmitted precoding matrix indicator, a resource allocation information, a transmission layer information, a modulation and coding scheme information, and a DMRS sequence generator information.

At step 2030, the first electronic device may receive a data package including uplink data from the second electronic device based on the data collection configuration and the data collection request. The uplink data may be associated with uplink signals from UEs (e.g., UEs 111-116 of FIGS. 1 and 3). The uplink data may include noisy signals received at a third electronic device (e.g., an O-RU 506 of FIG. 5), the decoded transport blocks, uplink-related downlink control information formats received from a medium access control scheduler, and a PUSCH configuration information obtained from an F1 application protocol module.

At step 2040, the first electronic device may reconstruct the uplink signals using respective decoded transport blocks and the signal reconstruction parameters.

At step 2050, the first electronic device may estimate a channel matrix and an interference and noise covariance matrix using the reconstructed uplink signals.

In one embodiment, the first electronic device may train an off-line AI model to perform channel estimation based on the reconstructed uplink signals, the estimated channel matrix, and the estimated interference and noise covariance matrix, and update a target AI model disposed at the second electronic device using the trained off-line AI model.

In one embodiment, the first electronic device may receive, from a fourth electronic device (e.g., an O-CU-CP 506 or O-CU-UP 508 of FIG. 5), uplink-related parameters included in a radio resource configuration through an O1 interface.

In one embodiment, the first electronic device may receive a data collection termination signal indicating incorrect decoding associated with the uplink data.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A method comprising:
receiving, by a first electronic device, a data collection capability report from a second electronic device in response to a request;
transmitting, by the first electronic device, a data collection configuration and a data collection request to the second electronic device, the data collection configuration including data types for data collection and signal reconstruction parameters;
receiving, by the first electronic device, a data package including uplink data from the second electronic device based on the data collection configuration and the data collection request, the uplink data associated with uplink signals from user equipments (UEs);
reconstructing, by the first electronic device, the uplink signals using respective decoded transport blocks and the signal reconstruction parameters; and
estimating, by the first electronic device, a channel matrix and an interference and noise covariance matrix using the reconstructed uplink signals.

2. The method of claim 1, further comprising:
training, by the first electronic device, an off-line artificial intelligence (AI) model to perform channel estimation based on the reconstructed uplink signals, the estimated channel matrix, and the estimated interference and noise covariance matrix; and
updating, by the first electronic device, a target AI model disposed at the second electronic device using the trained off-line AI model.

3. The method of claim 1, wherein the uplink data comprises noisy signals received at a third electronic device, the decoded transport blocks, uplink-related downlink control information formats received from a medium access control scheduler, and a PUSCH configuration information obtained from an F1 application protocol module.

4. The method of claim 1, further comprising:
receiving, from a fourth electronic device, uplink-related parameters included in a radio resource configuration through an O1 interface.

5. The method of claim 1, wherein the data collection capability report includes storage capacity of the second electronic device, one or more support indicators associated with one or more condition evaluators, and key performance indicators that the one or more condition evaluators are capable of evaluating.

6. The method of claim 1, wherein:
the data types comprise a physical uplink shared channel related data type, a demodulation reference signal (DMRS) related data type, and a phase tracking reference signal related data type; and
the signal reconstruction parameters comprise at least a UE transmitted precoding matrix indicator, a resource allocation information, a transmission layer information, a modulation and coding scheme information, and a DMRS sequence generator information.

7. The method of claim 1, further comprising:
receiving, by the first electronic device, a data collection termination signal indicating incorrect decoding associated with the uplink data.

8. A first electronic device comprising:
memory; and
a processor operably coupled to the memory, the processor configured to:
receive a data collection capability report from a second electronic device in response to a request;
transmit a data collection configuration and a data collection request to the second electronic device, the data collection configuration including data types for data collection and signal reconstruction parameters;
receive a data package including uplink data from the second electronic device based on the data collection configuration and the data collection request, the uplink data associated with uplink signals from user equipments (UEs);
reconstruct the uplink signals using respective decoded transport blocks and the signal reconstruction parameters; and
estimate a channel matrix and an interference and noise covariance matrix using the reconstructed uplink signals.

9. The first electronic device of claim 8, wherein the processor is further configured to:
train an off-line artificial intelligence (AI) model to perform channel estimation based on the reconstructed uplink signals, the estimated channel matrix, and the estimated interference and noise covariance matrix; and
update a target AI model disposed at the second electronic device using the trained off-line AI model.

10. The first electronic device of claim 8, wherein the uplink data comprises noisy signals received at a third electronic device, the decoded transport blocks, uplink-related downlink control information formats received from a medium access control scheduler, and a PUSCH configuration information obtained from an F1 application protocol module.

11. The first electronic device of claim 8, wherein the processor is further configured to receive, from a fourth electronic device, uplink-related parameters included in a radio resource configuration through an O1 interface.

12. The first electronic device of claim 8, wherein the data collection capability report includes storage capacity of the second electronic device, one or more support indicators associated with one or more condition evaluators, and key performance indicators that the one or more condition evaluators are capable of evaluating.

13. The first electronic device of claim 8, wherein:
the data types comprise a physical uplink shared channel related data type, a demodulation reference signal (DMRS) related data type, and a phase tracking reference signal related data type; and
the signal reconstruction parameters comprise at least a UE transmitted precoding matrix indicator, a resource allocation information, a transmission layer information, a modulation and coding scheme information, and a DMRS sequence generator information.

14. The first electronic device of claim 8, wherein the processor is further configured to receive a data collection termination signal indicating incorrect decoding associated with the uplink data.

15. A non-transitory computer readable medium embodying a computer program, the computer program comprising program code that, when executed by a processor of a first electronic device, causes the first electronic device to:
receive a data collection capability report from a second electronic device in response to a request;
transmit a data collection configuration and a data collection request to the second electronic device, the data collection configuration including data types for data collection and signal reconstruction parameters;
receive a data package including uplink data from the second electronic device based on the data collection configuration and the data collection request, the uplink data associated with uplink signals from user equipments (UEs);
reconstruct the uplink signals using respective decoded transport blocks and the signal reconstruction parameters; and
estimate a channel matrix and an interference and noise covariance matrix using the reconstructed uplink signals.

16. The non-transitory computer readable medium of claim 15, further comprising program code that, when executed by the processor of the first electronic device, causes the first electronic device to:
train an off-line artificial intelligence (AI) model to perform channel estimation based on the reconstructed uplink signals, the estimated channel matrix, and the estimated interference and noise covariance matrix; and
update a target AI model disposed at the second electronic device using the trained off-line AI model.

17. The non-transitory computer readable medium of claim 15, wherein the uplink data comprises noisy signals received at a third electronic device, the decoded transport blocks, uplink-related downlink control information formats received from a medium access control scheduler, and a PUSCH configuration information obtained from an F1 application protocol module.

18. The non-transitory computer readable medium of claim 15, further comprising program code that, when executed by the processor of the first electronic device, causes the first electronic device to:
receive, from a fourth electronic device, uplink-related parameters included in a radio resource configuration through an O1 interface.

19. The non-transitory computer readable medium of claim 15, wherein the data collection capability report includes storage capacity of the second electronic device, one or more support indicators associated with one or more condition evaluators, and key performance indicators that the one or more condition evaluators are capable of evaluating.

20. The non-transitory computer readable medium of claim 15, wherein:
the data types comprise a physical uplink shared channel related data type, a demodulation reference signal (DMRS) related data type, and a phase tracking reference signal related data type; and
the signal reconstruction parameters comprise at least a UE transmitted precoding matrix indicator, a resource allocation information, a transmission layer information, a modulation and coding scheme information, and a DMRS sequence generator information.
